(19) United States
(12) Patent Application Publication
(10) Pub. No.: US 2018/0053390 A1
(43) Pub. Date: Feb. 22, 2018

(54) INFANT ANTI-ABANDONMENT SYSTEM AND METHOD

(71) Applicants: Roger D. Morris, Owensboro, KY (US); Vicki Howe, Owensboro, KY (US); Jason R. Gaddis, Owensboro, KY (US)

(72) Inventors: Roger D. Morris, Owensboro, KY (US); Vicki Howe, Owensboro, KY (US); Jason R. Gaddis, Owensboro, KY (US)

(21) Appl. No.: 15/472,239

(22) Filed: Mar. 28, 2017

Related U.S. Application Data
(60) Provisional application No. 62/375,602, filed on Aug. 16, 2016.

(51) Int. Cl. G08B 21/02; B60Q 9/00

(52) U.S. Cl. CPC G08B 21/0202; B60Q 9/00

(57) ABSTRACT

An infant anti-abandonment system and method includes an electrical communication network installed OEM into a vehicle, a transmitter coupled to the electrical communication network including, a plurality of weight detection sensors installed in the vehicle seats and at least one child car-seat, a wireless link between the electrical communication network and the plurality of weight detection sensors, a timer and an alarm. The infant anti-abandonment system and method is useful for alerting as to child-occupancy in an unattended vehicle.

### CROSS-REFERENCE TO RELATED APPLICATION

The present application is related to and claims priority to U.S. Provisional Patent Application No. 62/375,602 filed Aug. 16, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of motor vehicles and more specifically relates to vehicle safety devices.

### 2. Description of Related Art

There have been several hundred documented cases of child fatality due to exposure in an unattended vehicle in the United States. The fact is, even the most attentive and careful caregivers are not immune to accidentally forgetting a small child in a vehicle. In areas with even mild temperatures, this can lead to deadly circumstances. At seventy degrees Fahrenheit, on a sunny day, the internal temperature in a vehicle can rise to well over one hundred degrees in under one hour. In areas with more extreme temperatures, around eighty hundred degrees, in direct sunlight, a vehicle's internal temperature can easily break one hundred and fifty degrees in less than one hour.

Many modern motor vehicles are equipped with an alarm system to prevent theft. A car alarm is an electronic device installed in a vehicle which emits a high-volume sound (usually a siren, klaxon, prerecorded voice message, the vehicle's own horn or some combination thereof) when the conditions necessary for an alarm are met, as well as flashing some of the vehicles lights. A means for alerting individuals as to an unattended child left in a vehicle is desired.

U.S. Pat. No. 7,170,401 to Cole relates to a system to detect the presence of an unattended child in a vehicle. The described system to detect the presence of an unattended child in a vehicle detects the presence of an unattended child in a vehicle and when the child is so detected, disables the vehicle's door locks by preventing doors from being locked or remaining locked and sounds an alarm. The presence of a child is detected by measuring pressure on the back seat and measurements above a threshold limit signify if a child is present. Furthermore, if any of the rear seat belts are buckled a child is detected. The system can be shut off by the driver, although the system has an override in the shutoff mode so that if the temperature rises above or falls below a certain level and the presence of a child is detected, an alarm is sounded. In this mode, the presence of a child can also be detected by a motion sensor.

### BRIEF SUMMARY OF THE INVENTION

In view of the foregoing disadvantages inherent in the known vehicle safety devices art, the present disclosure provides a novel infant anti-abandonment system and method. The general purpose of the present disclosure, which will be described subsequently in greater detail, is to provide an infant anti-abandonment system and method.

An infant anti-abandonment system is disclosed herein. The system and method for alerting as to child-occupancy in a vehicle (infant anti-abandonment system) disclosed comprising: an electrical communication network installed OEM into the vehicle, a transmitter wirelessly linked to the electrical communication network, the electrical communication network including a plurality of weight detection sensors (or other suitable sensing means), links to the plurality of weight detection sensors, an alarm, and a timer. The system includes the electrical communication network, the transmitter, the alarm, and the timer in functional combination.

The transmitter is installed in communication with the plurality of weight detection sensors; the plurality of weight detection sensors able to detect a mass (weight of a child) present within the vehicle. The transmitter, when the vehicle is stationary, not in a running condition, and an operator is not present in a driver's seat, is configured to send a signal to the electrical communication network, then the signal is relayed to the alarm when the mass is detected within the vehicle and a pre-set time has expired on the timer. The system is structured and arranged to sound the alarm, as needed, to promote safety of child-occupants such that individuals are notified that a dangerous condition is present for the child-occupant(s) contained within the vehicle.

According to another embodiment, a method for alerting as to child-occupancy in a vehicle is also disclosed herein, the method comprising the steps of: installing a car-seat in an equipped vehicle, detecting a mass via weight detection sensors as to occupancy of a car-seat; the weight detection sensors detecting the occupancy of remaining the seats in the vehicle and if no other occupancy is detected in the remaining the seats of the vehicle, a transmitter sends a signal to an on-board computer, initiating a timer via the on-board computer at a pre-set interval of six minutes (in preferred embodiments). If the pre-set interval of six minutes expires before the weight detection sensors detect the occupancy of another seat being used in the vehicle, an alarm is triggered. The method further comprising the step of the alarm activating a horn and lights on the vehicle (or other indication means—sending a text, call or other) until occupancy of another the seat is detected by the weight detection sensors.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an infant anti-abandonment system and method, constructed and operative according to the teachings of the present disclosure.

FIG. 1 is a perspective view of the infant anti-abandonment system and method during an ‘in-use’ condition, according to an embodiment of the disclosure.

FIG. 2 is an interior perspective view of the infant anti-abandonment system and method of FIG. 1, according to an embodiment of the present disclosure.

FIG. 3 is a perspective view of the infant anti-abandonment system and method of FIG. 1, according to an embodiment of the present disclosure.

FIG. 4 is a cutaway perspective view of the infant anti-abandonment system and method of FIG. 1, according to an embodiment of the present disclosure.

FIG. 5 is a flow diagram illustrating a method of use for the system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a vehicle safety devices and more particularly to an infant anti-abandonment system and method as used to improve means for alerting as to child-occupancy in a vehicle in a potentially dangerous situation.

Generally, the infant anti-abandonment system may be comprised of two main components, the first of which may be a permanently installed electrical communication network installed in new vehicles by the manufacturer at the time of manufacturing (OEM). The second of which may be a wireless transmitter installed into a child seat by the manufacturer at the time of manufacturing. When these two components are installed into a vehicle, they allow safe operation without concern of a child being left in an unattended vehicle.

The electrical communication network which may be installed in the vehicle may be linked to a number of components. These components may include a plurality of weight detection sensors installed in the seats of the vehicle, a timer and an alarm which may be the existing alarm system installed in the vehicle by the manufacturer. The weight detection sensors may be distributed throughout the seats of the vehicle to allow the electrical communication network to detect whether a seat is presently occupied or not. The timer component may be set at a pre-set interval of six minutes. The alarm component of the present invention may be a pre-existing alarm installed in the vehicle by the manufacturer. All of these components, when implemented in concert will allow for greater safety of child-occupants of vehicles by allowing sufficient means for alerting to the child-occupancy in a vehicle.

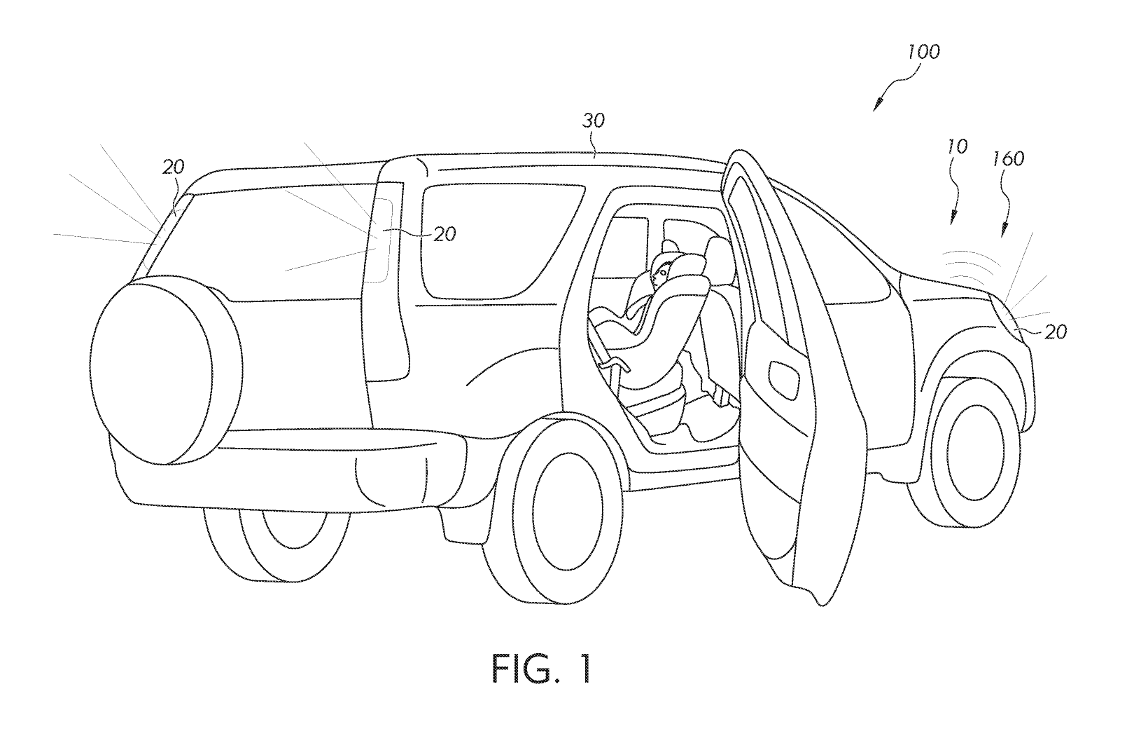

Referring now more specifically to the drawings by numerals of reference, there is shown in FIGS. 1-4, various views of a system and method for alerting as to child-occupancy in a vehicle 100. FIG. 1 shows a system and method for alerting as to child-occupancy in a vehicle 100 during an ‘in-use’ condition 150, according to an embodiment of the present disclosure. Here, the system and method for alerting as to child-occupancy in a vehicle 100 may be beneficial for use by a user 140 to alert as to the child-occupancy in a vehicle 30. As illustrated, the system and method for alerting as to child-occupancy in a vehicle 100 may include an electrical communication network 110 installed OEM into a vehicle 30 including, a plurality of weight detection sensors 130 installed in the seats of a vehicle 30 and a wireless transmitter 120 installed into a child seat at the time of manufacture coupled to the electrical communication network 110. The system and method for alerting as to child-occupancy in a vehicle 100 may further include a timer 170 and an alarm 160.

According to one embodiment, the system and method for alerting as to child-occupancy in a vehicle 100 may be arranged as a kit 105. In particular, the system and method for alerting as to child-occupancy in a vehicle 100 may further include a set of instructions 155. The instructions 155 may detail functional relationships in relation to the structure of the system and method for alerting as to child-occupancy in a vehicle 100 (such that the system and method for alerting as to child-occupancy in a vehicle 100 can be used, maintained, or the like, in a preferred manner).

In a preferred embodiment, the system 100 comprises an electrical communication network installed OEM into the vehicle 100, as previously mentioned. The electrical communications network 110 comprises an on-board computer 180, which is capable of detecting occupancy in each seat in the vehicle 30 and includes a plurality of weight detection sensors 130, an alarm 160, and a timer 170; wherein the timer 170 is activated when all of the seats are vacant except the seat located under the child-occupant. The system includes the electrical communication network 110, the transmitter 120, the alarm 160, and the timer 170 in functional combination; wherein the transmitter 120 is installed in communication with the plurality of weight detection sensors 130, the plurality of weight detection sensors 130 are able to detect a mass present on the seat within the vehicle 30 and the plurality of weight detection sensors 130 are installed in the seats of the vehicle 30.

The plurality of weight detection sensors 130 are capable of detecting the occupancy of the seats and the transmitter 120 is capable of communicating with the electrical communication network 110 preferably using short-wave length ultra high frequency radio waves in an ISM band from 2.4 to 2.485 GHz, such as those used in BLUETOOTH® devices. The transmitter 120, when the vehicle 30 is stationary, not in a running condition, and an operator or passenger is not present in a seat, is configured to send a signal to the electrical communication network 110 which is then relayed to the alarm 160 when the mass is detected within the vehicle 30 located in a car-seat and a pre-set time has expired on the timer 170. The timer 170 is set at a pre-set interval of six minutes in preferred embodiments. The timer 170 is set to run at the pre-set interval of six minutes upon the operator vacating the driver's seat; wherein the transmitter 120 receives the signal from the weight detection sensors 130, the on-board computer 180 receives the signal from the transmitter 120, the timer 170 receives the signal from the on-board computer 180, and the alarm 160 receives the signal from the timer 170, respectively. The alarm 160 is coupled with a horn 10 and lights 20 on the vehicle 30, so that the alarm 160 activates the horn 10 and the lights 20 on the vehicle 30 when the timer 170 expires. The system is structured and arranged to sound the alarm 160, as needed, to promote safety of child-occupants such that individuals are notified that a dangerous condition is present for the child-occupants present within the vehicle 30.

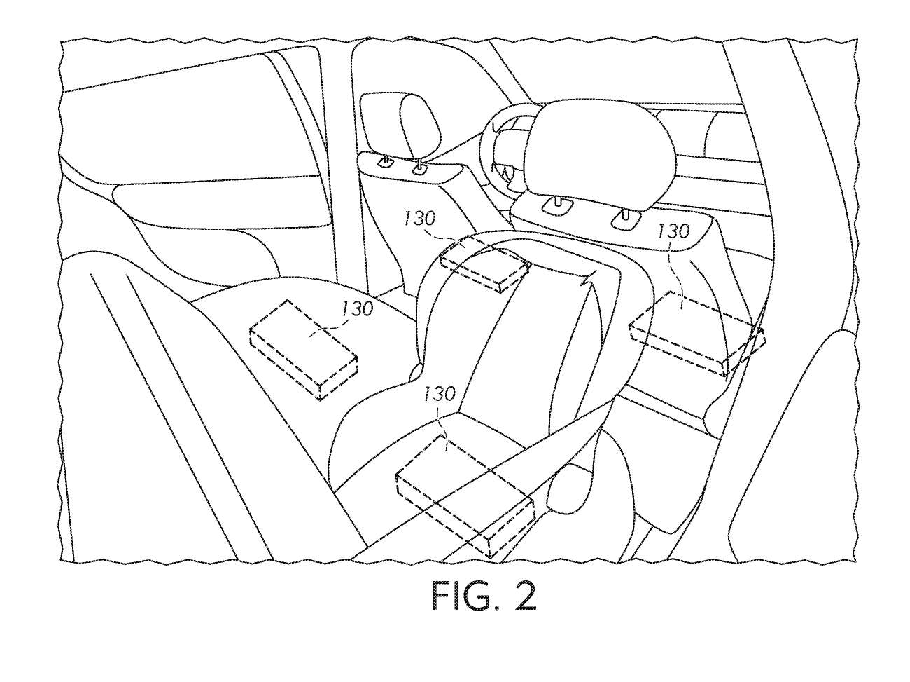

FIG. 2 shows the system and method for alerting as to child-occupancy in a vehicle 100 of FIG. 1, according to an embodiment of the present disclosure.

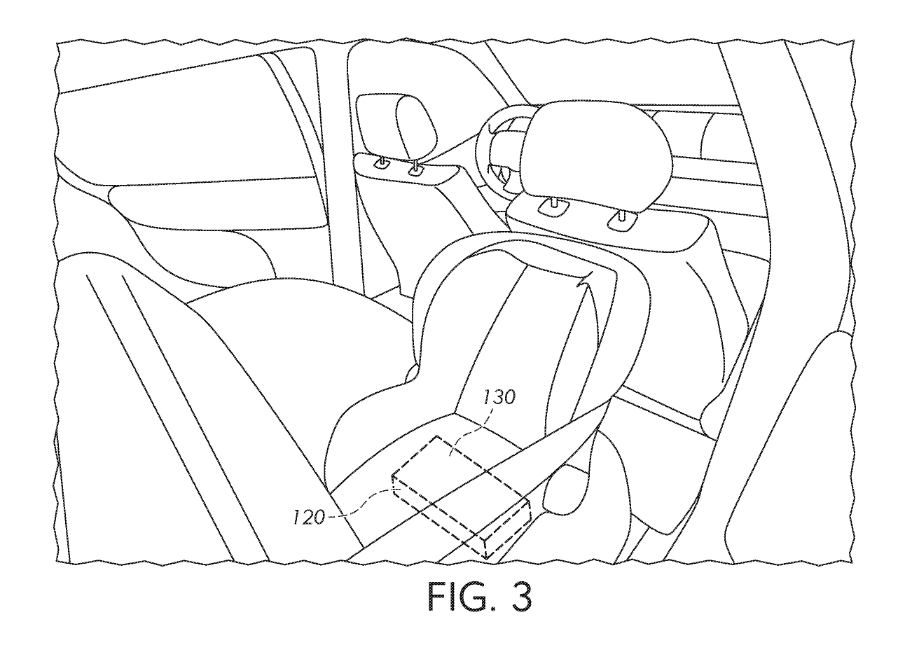

A plurality of weight detection sensors 130 are installed in seats of the vehicle 30. At least one weight detection sensor 130 is installed in a car-seat able to be placed in the vehicle 30, as shown in FIG. 3, the plurality of weight detection sensors 130 being capable of detecting the occupancy of the seats. The plurality of weight detection sensors 130 are capable of detecting the occupancy of a car-seat.

FIG. 3 is a perspective view of the system and method for alerting as to child-occupancy in a vehicle 100 of FIG. 1, according to an embodiment of the present disclosure. Referring now again to the transmitter 120; the transmitter 120 is capable of communicating with the electrical communication network 110 using short-wave length ultra-high frequency radio waves in an ISM band from 2.4 to 2.485 GHz. The transmitter 120 receives the signal from the weight detection sensors 130, the on-board computer 180 receives the signal from the transmitter 120, the timer 170 receives the signal from the on-board computer 180, and the alarm 160 receives the signal from the timer 170, respectively. Each of the signals are broadcast using the short-wavelength ultra high frequency radio waves in the ISM band from 2.4 to 2.475 GHz in so-equipped embodiments. Other means may be used.

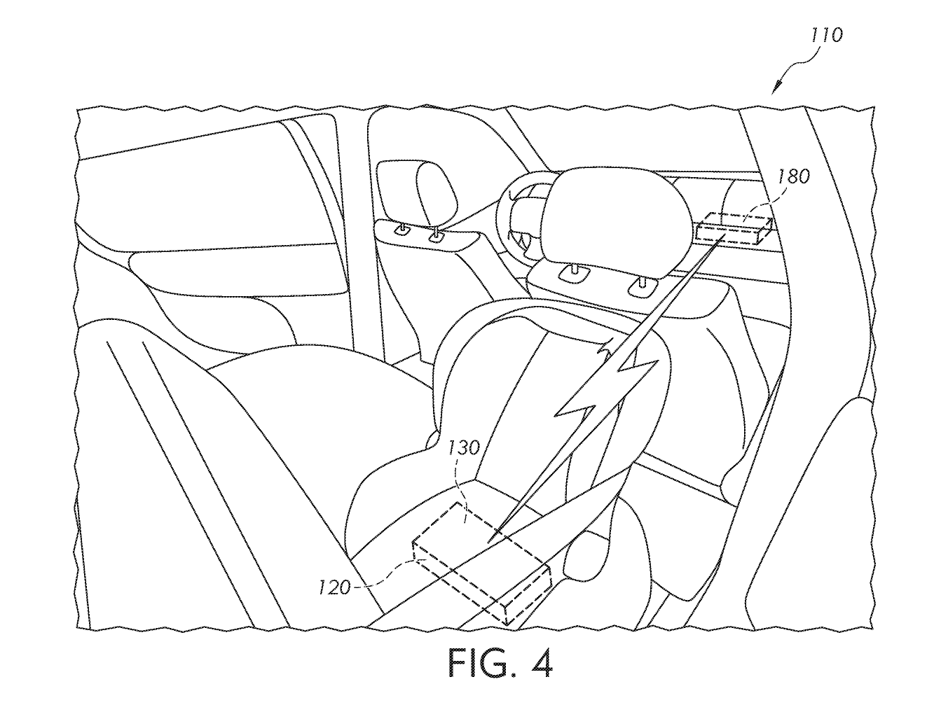

FIG. 4 is a cutaway perspective view of the system and method for alerting as to child-occupancy in a vehicle 100 of FIG. 1, according to an embodiment of the present disclosure.

The timer 170 is preferably set at a pre-set interval of six minutes. The timer 170 is set to initiate at the pre-set interval of six minutes upon the operator vacating the driver's seat and is also activated when all of the seats are vacant except the seat located under the child-occupant. The alarm 160 is coupled with the horn 10 and lights 20 on the vehicle 30 and activates the horn 10 and lights 20 on the vehicle 30 when the timer 170 expires. The electrical communications network 110 comprises an on-board computer 180 which is capable of detecting the occupancy in each seat in the vehicle 30. The timer 170 is also able to be set at a pre-set interval of less than six minutes or more if desired.

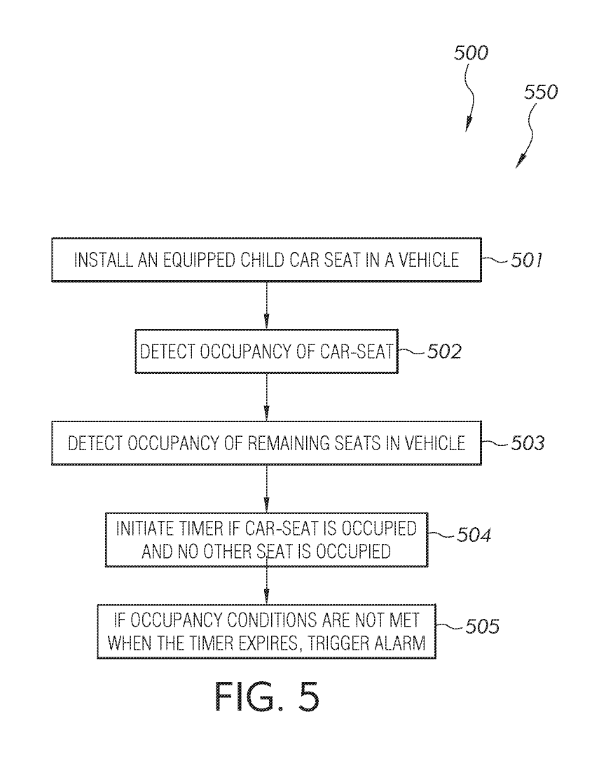

FIG. 5 is a flow diagram illustrating a method of use 500 for system for alerting as to child-occupancy in a vehicle 100, according to an embodiment of the present disclosure. In particular, the method 500 for the system for alerting as to child-occupancy in a vehicle 100 may include one or more components or features of the system and method for alerting as to child-occupancy in a vehicle 100 as described above.

As illustrated, the method of use 500 for system for alerting as to child-occupancy in a vehicle 100 may include the steps of: step one 501, installing a car-seat in an equipped vehicle 30; step two 502, detecting a mass via weight detection sensors 130 as to occupancy of a car-seat; step three 503, the weight detection sensors 130 detecting the occupancy of remaining seats in the vehicle 30 and if no the occupancy is detected in the remaining seats of the vehicle 30, a transmitter 120 sends a signal to an on-board computer 180; step four 504, initiating a timer 170 (automatically) via the on-board computer 180 at a pre-set interval of six minutes; step five 505, if the pre-set interval of six minutes expires before the weight detection sensors 130 detect the occupancy of another seat in the vehicle 30, an alarm 160 is triggered. The method 500 may further comprise the step 506 of the alarm 160 activating a horn 10 and lights 20 on the vehicle 30 until occupancy of another the seat is detected by the weight detection sensors 130.

It should be noted that step 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for alerting as to child-occupancy in a vehicle 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system and method for alerting as to child-occupancy in a vehicle, the system comprising:
an electrical communication network installed OEM into the vehicle;
a transmitter coupled to the electrical communication network, the transmitter including
a plurality of weight detection sensors, and
the electrical communication network linked to the plurality of weight detection sensors, and
an alarm;
a timer; and
wherein said system includes said electrical communication network, said transmitter, said alarm, and said timer in functional combination;
wherein said transmitter is installed in communication with said plurality of weight detection sensors, said plurality of weight detection sensors able to detect a mass present within said vehicle;
wherein said transmitter, when said vehicle is stationary, not in a running condition, and an operator is not present in a driver's seat, is configured to send a signal to said electrical communication network then relayed to said alarm when said mass is detected within said vehicle and a pre-set time has expired on said timer; and
wherein said system is structured and arranged to sound said alarm, as needed, to promote safety of child-occupants such that individuals are notified that a dangerous condition is present for said child-occupants present within said vehicle.

2. The system of claim 1, wherein the transmitter is capable of communicating with said electrical communication network using short-wave length ultra high frequency radio waves in an ISM band from 2.4 to 2.485 GHz.

3. The system of claim 2, wherein said plurality of weight detection sensors are installed in seats of said vehicle.

4. The system of claim 1, wherein said plurality of weight detection sensors are installed in a car-seat able to be placed in said vehicle.

5. The system of claim 1, wherein the timer is set at a pre-set interval of six minutes.

6. The system of claim 5, wherein the timer is set at said pre-set interval of six minutes upon said operator vacating said driver's seat.

7. The system of claim 1, wherein the alarm is coupled with the horn and lights on said vehicle.

8. The system of claim 7, wherein the alarm activates the horn and lights on said vehicle when said timer expires.

9. The system of claim 3, wherein the electrical communications network comprises an on-board computer.

10. The system of claim 9, wherein the on-board computer is capable of detecting occupancy in each said seat in said vehicle.

11. The system of claim 1, wherein the timer is activated when all of said seats are vacant except said seat located under said child-occupant.

12. The system of claim 3, wherein the plurality of weight detection sensors are capable of detecting the occupancy of said seats.

13. The system of claim 4, wherein the plurality of weight detection sensors are capable of detecting the occupancy of said car-seat.

14. The system of claim 9, wherein the transmitter receives the signal from said weight detection sensors, the on-board computer receives the signal from said transmitter, the timer receives the signal from said on-board computer, and the alarm receives the signal from said timer, respectively.

15. The system of claim 14, wherein the signals are broadcast using said short-wavelength ultra high frequency radio waves in said ISM band from 2.4 to 2.475 GHz.

16. The system of claim 1, wherein the timer is able to be set at a pre-set interval of less than six minutes.

17. A system and method for alerting as to child-occupancy in a vehicle, the system comprising:
an electrical communication network installed OEM into the vehicle;
wherein the electrical communications network comprises an on-board computer;
wherein the on-board computer is capable of detecting occupancy in each seat in said vehicle;
a transmitter coupled to the electrical communication network, the transmitter including a plurality of weight detection sensors, and
the electrical communication network linked to the plurality of weight detection sensors, an alarm; and
a timer;
wherein the timer is activated when all of said seats are vacant except said seat located under said child-occupant;
wherein said system includes said electrical communication network, said transmitter, said alarm, and said timer in functional combination;
wherein said transmitter is installed in communication with said plurality of weight detection sensors, said plurality of weight detection sensors able to detect a mass present on said seat within said vehicle;
wherein said plurality of weight detection sensors are installed in said seats of said vehicle;
wherein the plurality of weight detection sensors are capable of detecting the occupancy of said seats;
wherein the transmitter is capable of communicating with said electrical communication network using short-wave length ultra high frequency radio waves in an ISM band from 2.4 to 2.485 GHz;
wherein said transmitter, when said vehicle is stationary, not in a running condition, and an operator is not present in a driver's seat, is configured to send a signal to said electrical communication network then relayed to said alarm when said mass is detected within said vehicle located in a car-seat and a pre-set time has expired on said timer; and
wherein said timer is set at a pre-set interval of six minutes;
wherein said timer is set to run a said pre-set interval of six minutes upon said operator vacating said driver's seat;
wherein the transmitter receives the signal from said weight detection sensors, the on-board computer receives the signal from said transmitter, the timer receives the signal from said on-board computer, and the alarm receives the signal from said timer, respectively;
wherein the alarm is coupled with a horn and lights on said vehicle;
wherein the alarm activates the horn and the lights on said vehicle when said timer expires; and
wherein said system is structured and arranged to sound said alarm, as needed, to promote safety of child-occupants such that individuals are notified that a dangerous condition is present for said child-occupants present within said vehicle.

18. The system of claim 17, further comprising set of instructions; and
wherein the system is arranged as a kit.

19. A method for alerting as to child-occupancy in a vehicle, the method comprising the steps of:
installing a car-seat in an equipped said vehicle;
detecting a mass via weight detection sensors as to occupancy of a car-seat, said weight detection sensors detecting the occupancy of remaining said seats in said vehicle and if no said occupancy is detected in said remaining said seats of said vehicle, a transmitter sends a signal to an on-board computer; and
initiating a timer via said on-board computer at a pre-set interval of six minutes and if pre-set interval of six minutes expires before said weight detection sensors detect the occupancy of another said seat in said vehicle, an alarm is triggered.

20. The method of claim 19, further comprising the step of said alarm activating a horn and lights on said vehicle until occupancy of another said seat is detected by said weight detection sensors.
